(19) United States
(12) Patent Application Publication
(10) Pub. No.: US 2026/0197065 A1
(43) Pub. Date: Jul. 9, 2026

(54) Enhancements for Intra-Frequency Inter-Cell GBBR

(71) Applicant: Apple Inc., CUPERTINO, CA (US)

(72) Inventors: Jie CUI, San Jose, CA (US); Konstantinos SARRIGEORGIDIS, Los Gatos, CA (US); Manasa RAGHAVAN, Sunnyvale, CA (US); Qiming LI, Beijing (CN); Xiang CHEN, Campbell, CA (US); Yang TANG, San Jose, CA (US)

(21) Appl. No.: 18/730,009

(22) PCT Filed: Jul. 21, 2023
(86) PCT No.: PCT/CN2023/108637

§ 371 Date: Jul. 18, 2024

(51) Int. Cl. H04B 7/06; H04W 72/0446

(52) U.S. Cl. CPC H04B 7/06952; H04W 72/0446

(57) ABSTRACT

A user equipment (UE) is configured to determine whether layer 3 (L3) synchronization signal blocks (SSB)-measurements can be completed on two or more antenna panels, configure SSB based group-based beam reporting (GBBR) measurement for a first antenna panel and a second antenna panel of the two or more antenna panels, wherein the SSB based GBBR measurement comprise a beam sweeping factor and perform GBBR measurement of synchronization signal blocks (SSBs) from two cells.

### TECHNICAL FIELD

The present disclosure generally relates to wireless communication, and in particular, to enhancements for intra-frequency inter-cell GBBR.

### BACKGROUND

A user equipment (UE) may engage in group-based beam reporting (GBBR). GBBR allows for beam management on a collection of beams, rather than on an individual beam basis. Following beam sweeping and beam measurement operations, a UE may perform beam reporting (in this case, group-based reporting) back to a gNodeB (gNB). Currently, GBBR has only been considered from the standpoint of multiple transmission and reception points (TRPs) in a same serving cell.

However, if intra-frequency inter-cell GBBR is considered, the scenario is quite different from the legacy case of multiple TRPs in the same serving cell. There are numerous issues that need to be resolved for intra-frequency inter-cell GBBR, such as, for example, synchronization signal block (SSB) collision logic (from both the UE and network perspective), improved candidate resource set list design, and association logic between SSBs and Channel State Information Reference Signals (CSI-RS) that are configured in a GBBR resource set.

### SUMMARY

Some exemplary embodiments are related to an apparatus of a user equipment (UE) having processing circuitry configured to determine whether layer 3 (L3) synchronization signal blocks (SSB)-measurements can be completed on two or more antenna panels, configure SSB based group-based beam reporting (GBBR) measurement for a first antenna panel and a second antenna panel of the two or more antenna panels, wherein the SSB based GBBR measurement comprise a beam sweeping factor and perform GBBR measurement of synchronization signal blocks (SSBs) from two cells.

Other exemplary embodiments are related to an apparatus of a base station having processing circuitry configured to configure one or more channel state reference signal (CSI-RS) resources in one or more resource sets, wherein the configuration comprises a synchronization signal block (SSB) associated with CSI-RS in each resource set and configure transceiver circuitry to transmit the configured resources to a user equipment (UE).

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows a network arrangement having a UE and three (3) cells according to various exemplary embodiments.

FIG. 5 shows an exemplary method for performing GBBR measurements for collided SSBs according to various exemplary embodiments.

FIG. 6 shows an exemplary method for performing GBBR measurements for non-collided SSBs according to various exemplary embodiments.

FIG. 7 shows a call flow diagram for association between SSB and CSI-RS if CSI-RS is configured in a GBBR resource set according to various exemplary embodiments.

### DETAILED DESCRIPTION

The exemplary embodiments may be further understood with reference to the following description and the related appended drawings, wherein like elements are provided with the same reference numerals. The exemplary embodiments relate to GBBR reporting, specifically, intra-frequency inter-cell GBBR.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol (e.g., 6G networks), or any other type of network.

The exemplary embodiments provide various aspects related to intra-frequency inter-cell GBBR. In a first aspect of the exemplary embodiments, logic for handling collided SSBs from both the UE and network perspective for GBBR is described. From the network perspective, the logic indicates whether the network should configure resource sets for GBBR with collided SSBs on different cells or non-collided SSBs on different cells. From the UE perspective, the logic indicates how the UE should perform layer 3 (L3) SSB measurements on collided or non-collided SSB resources. In a second aspect of the exemplary embodiments, a candidate resource set list design for SSB is described.

In a third aspect of the exemplary embodiments, for CSI-RS-based inter-cell GBBR, association procedures between SSBS and CSI-RS are described. In a fourth aspect of the exemplary embodiments, a new candidate resource set design for CSI-RS-based inter-cell GBBR is disclosed.

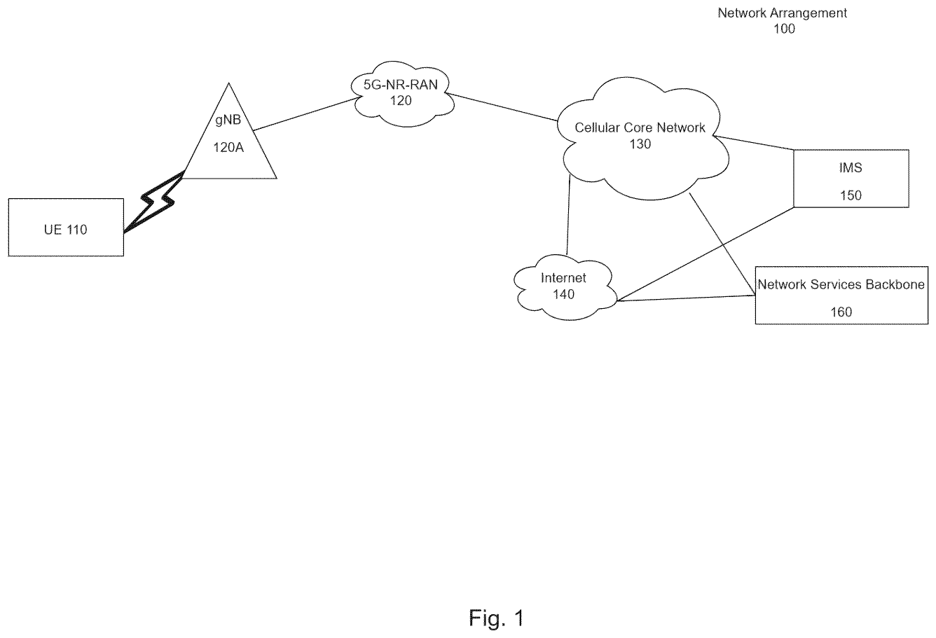

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices (including connected vehicles), etc. It should also be understood that an actual network arrangement may include any number of UEs being used by any number of users. Thus, the example of one UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.). In this network arrangement 100 a single gNB 120A is shown for illustrative purposes. However, as will be described in greater detail below, the exemplary embodiments are related to GBBR reporting in an intra-frequency inter-cell scenario. Thus, as will be described and illustrated below, the UE 110 may perform GBBR based on signals received from two or more base stations, e.g., gNBs.

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

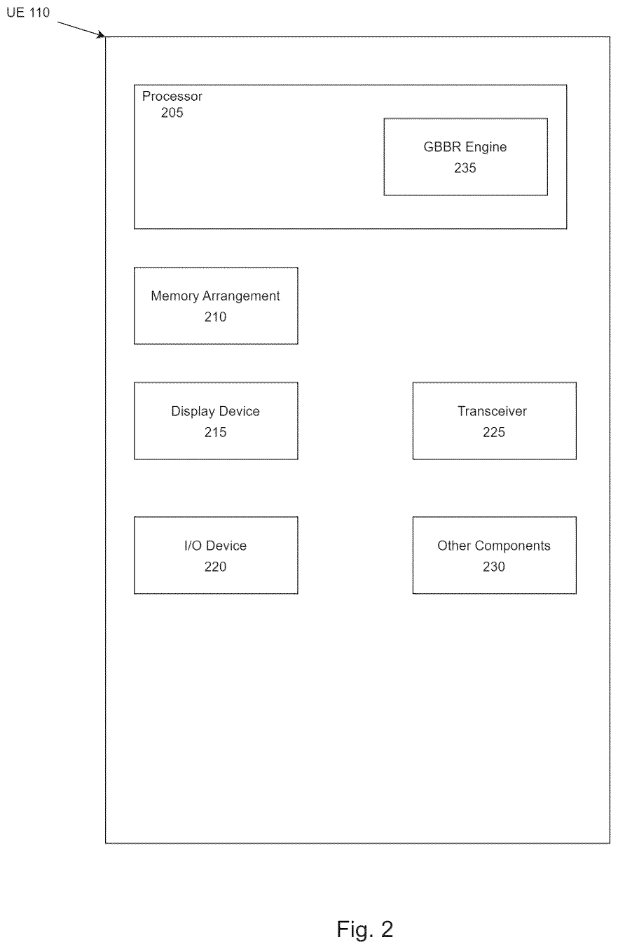

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include an GBBR engine 235 for performing operations related to processing for SSB collision, candidate resource set lists, and association between SSBs and CSI-RS.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120. Accordingly, the transceiver 225 may operate on a variety of different frequencies or channels (e.g., set of consecutive frequencies).

The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

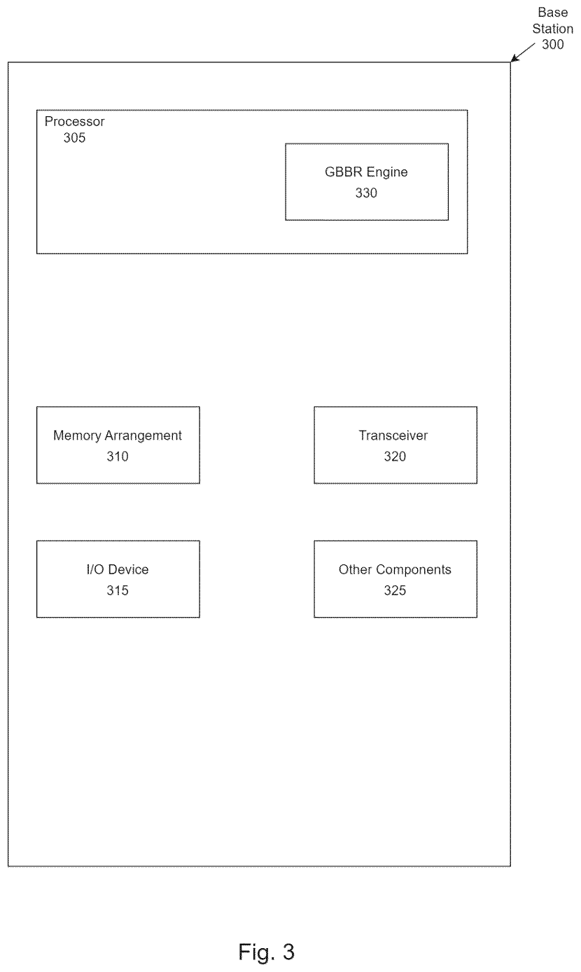

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include an GBBR engine 330 for performing operations related to processing for SSB collision, candidate RS lists, and association between SSBs and CSI-RS.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

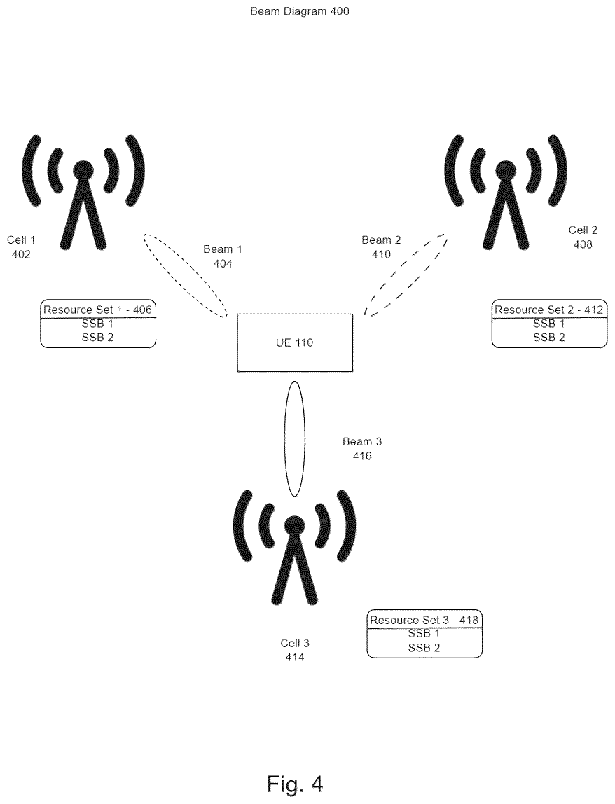

FIG. 4 shows a network arrangement 400 having a UE 110 and three (3) cells 402, 408 and 414 according to various exemplary embodiments. In this example, there are three cells but it should be understood that the exemplary intra-frequency inter-cell GBBR may be applied to any scenario involving two (2) or more cells. The network arrangement 400 shows a cell 1 402. The cell 1 402 may be understood to be equivalent in functionality to the gNB 120A. The cell 1 402 and the UE 110 share a beam 1 404. The cell 1 402 also has an associated resource set 1 406 with an SSB 1 and an SSB 2.

In a substantially similar manner, the network arrangement 400 also has a cell 2 408 (with a beam 2 410) and a resource set 2 412 (with an SSB 1 and SSB 2) along with the cell 3 414 (with a beam 3 416) and a resource set 3 418 (with an SSB 1 and SSB 2). These cells, beams and resources may be understood to be of substantially similar functionality to those described with respect to the cell 1 402.

In the network arrangement 400, it may be considered that the resource sets 406, 412, and 418 each have their own SSBs with the same index (e.g., SSB 1 and SSB 2). One of skill in the art will appreciate that SSBs with different indexes are typically time domain multiplexed (TDMed). This presents a problem, because the resource sets 406, 412, and 418 share SSB indexes 1 and 2. This overlap means that SSBs may be collided on the time domain.

In a first aspect of the exemplary embodiments, SSB collision logic from both the UE and network perspective for GBBR is disclosed herein. Collided SSBs may refer to SSBs with the same index if their associated cells are synchronized to each other, or if SSBs a have a different index but are colliding on the time domain.

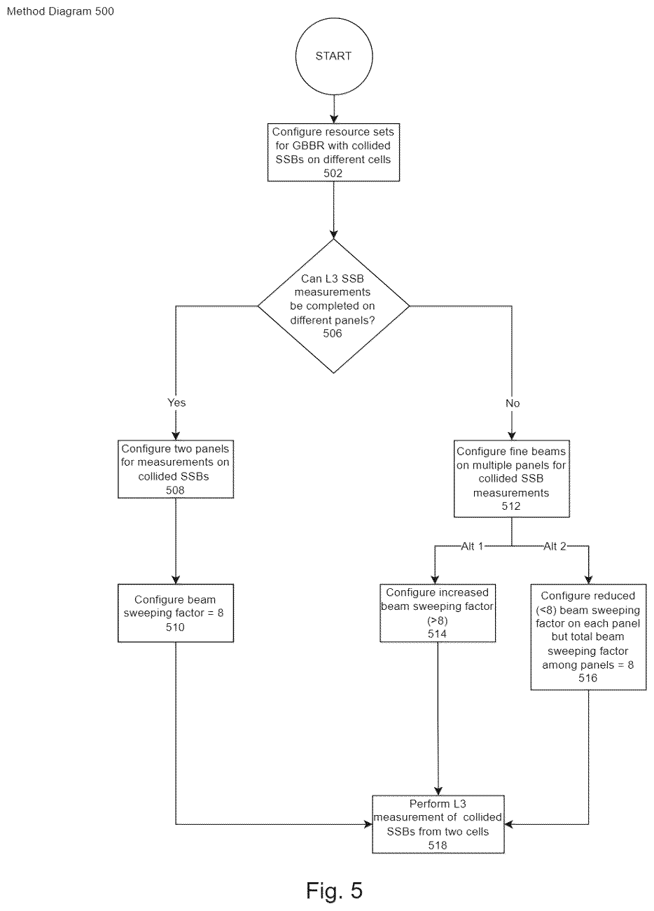

FIG. 5 shows an exemplary method 500 for performing GBBR measurements for collided SSBs according to various exemplary embodiments. The method diagram 500 may be understood to describe a first option of the first aspect. FIG. 5 has operations from both the network and UE perspective, and such perspectives will be appropriately indicated.

GBBR measurements and their associated measurement reports assist a network in determining which transmission beams may be used simultaneously to serve a UE, or to schedule channels to the UE. In an illustrative example, a first cell may use SSBs indexed 1, 2, 3, and 4. A second cell may use SSBs indexed 1, 2, 5, and 6. Using GBBR measurements with collided SSBs (e.g., SSBs 1 and 2 in the above example) may better inform the network of the magnitude of interference between SSBs. This information may be lost during GBBR measurements not using collided SSBs.

In 502, the network configures resource sets for GBBR with collided SSBs (on the time domain) of different cells. For example, the network may configure SSB 1 and SSB 2 of resource sets 406 and 412, as shown in FIG. 4.

In 506, the UE 110 determines whether L3 SSB measurements may be completed on different antenna panels. For example, if L3 measurement of SSBs indicates the SSBs from two cells may not completely separated on different panels, the answer in 506n is negative. However, if L3 measurement of SSBs indicates the SSBs from two cells may be separated on different panels, the answer to 506 is positive. If the answer to 506 is yes, the UE 110 proceeds to 508. It should be noted that the configuration operations 508 and 510 are presented as discrete steps in a temporal relationship (508 occurring before 510), but this is only exemplary. For example, these operations may occur simultaneously or in a reversed order without changing the scope of the exemplary embodiments. This description of temporality is also applicable to operation 512 and either alternative 1 (shown in 514) or alternative 2 (shown in 516).

It should be noted that following operations 510, 514, and 516, the UE 110 performs operation 518, which will be discussed below.

In 508, the UE 110 configures two antenna panels for measurement on collided SSBs (e.g., SSB 1 and SSB 2). In 510, the UE 110 configures a beam sweeping factor to eight.

If the answer to 506 is no, the UE 110 proceeds to 512. In 512, the UE 110 configures finer (i.e., narrower) beams on multiple panels for measurement of the SSBs.

In a first example, the UE 110 proceeds to 514. In 514, the UE 110 configures an increased beam sweeping factor (greater than eight) for each antenna panel. For example, the beam sweeping factor used may be 12 or 16.

In a second example, the UE 110 proceeds to 516. In 516, the UE 110 configures a reduced beam sweeping factor (less than eight) for each antenna panel. In the second example, the sum of the beam sweeping factors used equals 8. For example, the beam sweeping factor on a first panel may be 4 and the beam sweeping factor on a second panel may also be 4 (4+4=8).

At the conclusion of the operations 510, 514, and 516, the UE 110 proceeds to 518. In 518, the UE 110 performs L3 measurements of the collided SSBs from two cells. For example, if the UE 110 is proceeding from the operation 510, in 518 the UE 110 would use a beam sweeping factor of eight while performing L3 measurements.

In a second option of the first aspect of the exemplary embodiments, the network may configure resource sets for GBBR with non-collided SSBs from different cells. In some scenarios, this may be desirable to avoid low signal to interference ratio conditions for measurement (e.g., if selecting collided SSBs would result in poor measurement accuracy). Non-collided SSBs may refer to both SSBs with a different index if their associated cells are synchronized to each other, or if SSBs are not colliding on the time domain.

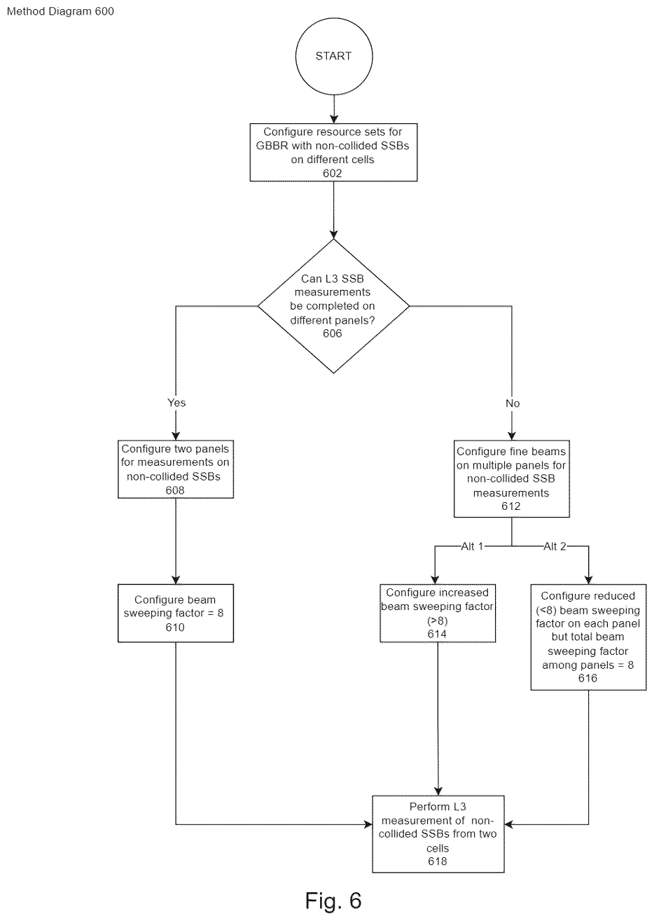

FIG. 6 shows an exemplary method 600 for performing GBBR measurements for non-collided SSBs according to various exemplary embodiments. The method 600 may be understood to describe a second option of the first aspect. FIG. 6 has operations from both the network and UE perspective, and such perspectives will be appropriately indicated.

In 602, the network configures resource sets for GBBR with non-collided SSBs (on the time domain) of different cells. For example, the network may configure SSB 1 and SSB 2 of the resource set 406 and an exemplary SSB 3 and SSB 4 (not shown in FIG. 4) of a fourth cell (not shown in FIG. 4).

In 606, the UE 110 determines whether L3 SSB measurements may be completed on different antenna panels (panels). If the answer to 606 is yes, the UE 110 proceeds to 608. It should be noted that the configuration operations 608 and 610 are presented as discrete steps in a temporal relationship (608 occurring before 610), but this is only exemplary. For example, these operations may occur simultaneously or in a reversed order without changing the scope of the exemplary embodiment. This description of temporality is also applicable to operation 612 and either alternative 1 (shown in 614) or alternative 2 (shown in 616).

It should be noted that following operations 610, 614, and 616, the UE performs operation 618, which will be discussed below.

In 608, the UE 110 configures two antenna panels for measurement on non-collided SSBs (e.g., SSB 1 and SSB 2). In 610, the UE 110 configures a beam sweeping factor to eight.

If the answer to 606 is no, the UE 110 proceeds to 612. In 612, the UE 110 configures finer (i.e., narrower) beams on multiple panels for measurement of SSBs.

In a first example, the UE 110 proceeds to 614. In 614, the UE 110 configures an increased beam sweeping factor (e.g., greater than eight) for each antenna panel. For example, the beam sweeping factor used may be 12 or 16.

In a second example, the UE 110 proceeds to 616. In 616, the UE 110 configures a reduced beam sweeping factor (i.e., less than eight) for each antenna panel. In the second alternative, the sum of the beam sweeping factors used equals 8. For example, the beam sweeping factor on a first panel may be 4 and the beam sweeping factor on a second panel may also be 4 (4+4=8).

At the conclusion of the operations 610, 614, and 616, the UE 110 proceeds to 618. In 618, the UE 110 performs L3 measurements of the non-collided SSBs from two cells. For example, if the UE 110 is proceeding from the operation 610, in 618 the UE 110 would use a beam sweeping factor of eight while performing L3 measurements.

In a second aspect of the exemplary embodiments, a candidate resource set list design for SSB is disclosed herein. Numerous options exist for grouping resource sets from the network. In a first option, one resource set may contain the same type of RSs of a same physical cell ID (PCI). In a second option, one resource set may contain different types of RSs of the same PCI. In a third option, one resource set may contain RSs that share a same timing source (e.g., SSBs of synchronized cells may be contained in the same resource set). In a fourth option, one resource set may contain the RSs that share a same Quasi-Colocation (QCL) source. For example, for SSB-based GBBR, SSBs may share the same transmission beam or a same transmission panel or a same TRP from a gNB.

In a third aspect of the exemplary embodiments, association procedures and logic between SSB and CSI-RS is disclosed herein. Specifically, the third aspect is related to situations in which the CSI-RS is configured in a GBBR resource set. One of skill in the art will recognize that CSI-RS alone cannot be used for timing synchronization; timing information must be derived from SSB measurements (e.g., via an L3 measurement).

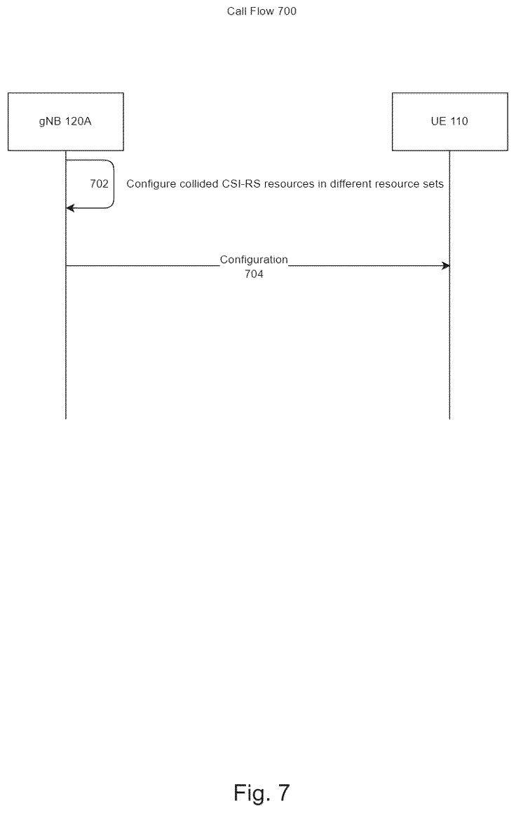

FIG. 7 shows a call flow diagram 700 for association between SSB and CSI-RS if CSI-RS is configured in a GBBR resource set according to various exemplary embodiments. FIG. 7 may be understood to describe the third aspect.

In 702, the network (e.g., the gNB 120A) configures collided CSI-RS resources in different resource sets. By measuring a single CSI-RS resource, the UE 110 may understand the signal strength and interference level. In other examples, the gNB 120A may not configure collided CSI-RS resources in different resource sets.

In 704, the gNB 120A transmits the associated SSB for CSI-RS in the resource set to the UE 110. In a first option, the associated SSB only provides beam source information for CSI-RS to the UE 110, but the CSI-RS timing may refer to its cell timing. One of skill in the art will recognize that the timing of a cell may or may not be the same as an associated SSB timing, because the associated SSB may not be the best (e.g., strongest) SSB of the cell. In a second option, the associated SSB provides both the beam source information for CSI-RS and CSI-RS timing to the UE 110.

In a fourth aspect of the exemplary embodiments, a new candidate resource set design for CSI-RS-based inter-cell GBBR is disclosed. In a first option, to group resources from the network, one resource set may contain the same type of resource sets of a same physical cell ID (PCI). In a second option, one resource set may contain different types of resource sets of the same PCI.

In a third option, one resource set may contain the resource sets that share a same timing source (e.g., SSBs of synchronized cells may be contained in the same resource set).

In a fourth option, one resource set may contain the resource sets that share a same Quasi-Colocation (QCL) source. For example, the fourth option may apply for CSI-RS QCL type D with a same SSB; or for CSI-RS QCL type D with one another, or for CSI-RS on a same QCL chain.

### Examples

In a first example, a method performed by a user equipment (UE), the method comprising determining whether layer 3 (L3) synchronization signal blocks (SSB)-measurements can be completed on two or more antenna panels, configuring SSB based group-based beam reporting (GBBR) measurement for a first antenna panel and a second antenna panel of the two or more antenna panels, wherein the SSB based GBBR measurement comprise a beam sweeping factor and performing GBBR measurement of synchronization signal blocks (SSBs) from two cells.

In a second example, the method of the first example, wherein the SSBs are collided in a time domain.

In a third example, the method of the second example, wherein, when SSB based GBBR measurements can be completed on different antenna panels of the two or more antenna panels, the processing circuitry configures the first antenna panel to perform SSB based GBBR for a first SSB and the second antenna panel to perform SSB based GBBR for a second SSB.

In a fourth example, the method of the third example, wherein the beam sweeping factor is equal to eight.

In a fifth example, the method of the second example, wherein, when SSB based GBBR cannot be completed on different antenna panels of the two or more antenna panels, the processing circuitry configures one or more beams of the first antenna panel and one or more beams of the second antenna panel to perform SSB based GBBR for a first SSB and one or more beams of the first antenna panel and one or more beams of the second antenna panel to perform SSB based GBBR for a second SSB.

In a sixth example, the method of the fifth example, wherein the beam sweeping factor is greater than eight.

In a seventh example, the method of the fifth example, wherein the beam sweeping factor is equal to a sum of first beam sweeping factors of the first antenna panel and a second beam sweeping factors of the second antenna panel, wherein the sum is equal to eight.

In an eighth example, the method of the first example, wherein the SSBs are not collided in a time domain.

In a ninth example, the method of the eighth example, wherein, when SSB based GBBR measurement can be completed on different antenna panels of the two or more antenna panels, the processing circuitry configures the first antenna panel to perform SSB based GBBR measurement for the first SSB and the second antenna panel to perform SSB based GBBR measurement for a second SSB.

In a tenth example, the method of the ninth example, wherein the beam sweeping factor is equal to eight.

In an eleventh example, the method of the eighth example, wherein, wherein, when SSB based GBBR measurement cannot be completed on different antenna panels of the two or more antenna panels, the processing circuitry configures one or more beams of the first antenna panel and one or more beams of the second antenna panel to perform SSB based GBBR measurement for a first SSB and one or more beams of the first antenna panel and one or more beams of the second antenna panel to perform SSB based GBBR measurement for a second SSB.

In a twelfth example, the method of the eleventh example, wherein, wherein the beam sweeping factor is greater than eight.

In a thirteenth example, the method of the eleventh example, wherein the beam sweeping factor is equal to a sum of first beam sweeping factors of the first antenna panel and a second beam sweeping factors of the second antenna panel, wherein the sum is equal to eight.

In a fourteenth example, the method of the first example, further comprising decoding, from signals received from a base station, one or more resource sets comprising the SSBs for the GBBR, wherein one resource set of the one or more resource sets comprises a same type of reference signals (RSs) sharing a same physical cell ID (PCI).

In a fifteenth example, the method of the first example, further comprising decoding, from signals received from a base station, one or more resource sets comprising the SSBs for the GBBR, wherein one resource set of the one or more resource sets further comprises different types of reference signals (RSs) sharing a same physical cell ID (PCI).

In a sixteenth example, the method of the first example, further comprising decoding, from signals received from a base station, one or more resource sets comprising the SSBs for the GBBR, wherein one resource set of the one or more resource sets further comprises reference signals (RSs) sharing a same timing source.

In a seventeenth example, the method of the first example, further comprising decoding, from signals received from a base station, one or more resource sets comprising the SSBs for the GBBR, wherein one resource set of the one or more resource sets further comprises reference signals (RSs) sharing a same quasi-colocation (QCL) source.

In an eighteenth example, a processor configured to perform any of the methods of the first through seventeenth examples.

In a nineteenth example, a method performed by a base station, the method comprising configuring one or more channel state reference signal (CSI-RS) resources in one or more resource sets, wherein the configuration comprises a synchronization signal block (SSB) associated with CSI-RS in each resource set and configuring transceiver circuitry to transmit the configured resources to a user equipment (UE).

In a twentieth example, the method of the nineteenth example, wherein the configured resources comprise collided CSI-RS resources in different resource sets.

In a twenty first example, the method of the nineteenth example, wherein the configured resources comprise CSI-RS resources in different resource sets are in a TDM(Time-division multiplexing) manner.

In a twenty second example, the method of the nineteenth example, wherein CSI-RS resources in a first resource set utilize cell specific timing as the timing source.

In a twenty third example, the method of the nineteenth example, wherein a first SSB associated with CSI-RS resources in a first resource set comprises beam source information for the CSI-RS resources in the first resource set.

In a twenty fourth example, the method of the nineteenth example, wherein a first SSB associated with CSI-RS resources in a first resource set comprises beam source information and timing information for the CSI-RS resources in the first resource set.

In a twenty fifth example, the method of the nineteenth example, wherein one resource set of the one or more resource sets comprises a same type of reference signals (RSs) sharing a same physical cell ID (PCI).

In a twenty sixth example, the method of the nineteenth example, wherein one resource set of the one or more resource sets further comprises different types of reference signals (RSs) sharing a same physical cell ID (PCI).

In a twenty seventh example, the method of the nineteenth example, wherein one resource set of the one or more resource sets further comprises reference signals (RSs) sharing a same timing source.

In a twenty eighth example, the method of the nineteenth example, wherein one resource set of the one or more resource sets further comprises reference signals (RSs) sharing a same quasi-colocation (QCL) source.

In an twenty ninth example, a processor configured to perform any of the methods of the nineteenth through twenty eighth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
determine whether layer 3 (L3) synchronization signal blocks (SSB)-measurements can be completed on two or more antenna panels;
configure SSB based group-based beam reporting (GBBR) measurement for a first antenna panel and a second antenna panel of the two or more antenna panels, wherein the SSB based GBBR measurement comprise a beam sweeping factor; and
perform GBBR measurement of synchronization signal blocks (SSBs) from two cells.

2. The apparatus of claim 1, wherein the SSBs are collided in a time domain.

3. The apparatus of claim 2, wherein, when SSB based GBBR measurements can be completed on different antenna panels of the two or more antenna panels, the processing circuitry configures the first antenna panel to perform SSB based GBBR for a first SSB and the second antenna panel to perform SSB based GBBR for a second SSB.

4. The apparatus of claim 3, wherein the beam sweeping factor is equal to eight.

5. The apparatus of claim 2, wherein, when SSB based GBBR cannot be completed on different antenna panels of the two or more antenna panels, the processing circuitry configures one or more beams of the first antenna panel and one or more beams of the second antenna panel to perform SSB based GBBR for a first SSB and one or more beams of the first antenna panel and one or more beams of the second antenna panel to perform SSB based GBBR for a second SSB.

6. The apparatus of claim 5, wherein the beam sweeping factor is greater than eight.

7. The apparatus of claim 5, wherein the beam sweeping factor is equal to a sum of first beam sweeping factors of the first antenna panel and a second beam sweeping factors of the second antenna panel, wherein the sum is equal to eight.

8. The apparatus of claim 1, wherein the SSBs are not collided in a time domain.

9. The apparatus of claim 8, wherein, when SSB based GBBR measurement can be completed on different antenna panels of the two or more antenna panels, the processing circuitry configures the first antenna panel to perform SSB based GBBR measurement for the first SSB and the second antenna panel to perform SSB based GBBR measurement for a second SSB.

10. The apparatus of claim 9, wherein the beam sweeping factor is equal to eight.

11. The apparatus of claim 8, wherein, when SSB based GBBR measurement cannot be completed on different antenna panels of the two or more antenna panels, the processing circuitry configures one or more beams of the first antenna panel and one or more beams of the second antenna panel to perform SSB based GBBR measurement for a first SSB and one or more beams of the first antenna panel and one or more beams of the second antenna panel to perform SSB based GBBR measurement for a second SSB.

12. The apparatus of claim 11, wherein the beam sweeping factor is greater than eight.

13. The apparatus of claim 11, wherein the beam sweeping factor is equal to a sum of first beam sweeping factors of the first antenna panel and a second beam sweeping factors of the second antenna panel, wherein the sum is equal to eight.

14. The apparatus of claim 1, wherein the processing circuitry is further configured to decode, from signals received from a base station, one or more resource sets comprising the SSBs for the GBBR, wherein one resource set of the one or more resource sets comprises a same type of reference signals (RSs) sharing a same physical cell ID (PCI).

15. The apparatus of claim 1, wherein the processing circuitry is further configured to decode, from signals received from a base station, one or more resource sets comprising the SSBs for the GBBR, wherein one resource set of the one or more resource sets further comprises different types of reference signals (RSs) sharing a same physical cell ID (PCI).

16. The apparatus of claim 1, wherein the processing circuitry is further configured to decode, from signals received from a base station, one or more resource sets comprising the SSBs for the GBBR, wherein one resource set of the one or more resource sets further comprises reference signals (RSs) sharing a same timing source.

17. The apparatus of claim 1, the processing circuitry is further configured to decode, from signals received from a base station, one or more resource sets comprising the SSBs for the GBBR, wherein one resource set of the one or more resource sets further comprises reference signals (RSs) sharing a same quasi-colocation (QCL) source.

18. An apparatus of a base station, the apparatus comprising processing circuitry configured to:
configure one or more channel state reference signal (CSI-RS) resources in one or more resource sets, wherein the configuration comprises a synchronization signal block (SSB) associated with CSI-RS in each resource set; and
configure transceiver circuitry to transmit the configured resources to a user equipment (UE).

19. The apparatus of claim 18, wherein the configured resources comprise collided CSI-RS resources in different resource sets.

20. The apparatus of claim 18, wherein the configured resources comprise CSI-RS resources in different resource sets are in a TDM(Time-division multiplexing) manner.
